(19) United States
(12) Patent Application Publication
(10) Pub. No.: US 2003/0154214 A1
(43) Pub. Date: Aug. 14, 2003

(54) Automatic storage and retrieval system and method for operating the same

(76) Inventors: Junh-Hsien Tu, Taipei (TW); Yi-Ming Liao, Taipei (TW); Shih-Chan Chen, Taipei (TW)

Correspondence Address: ROTHWELL, FIGG, ERNST & MANBECK, P.C., 1425 K STREET, N.W., SUITE 800, WASHINGTON, DC, 20005, US

(21) Appl. No.: 10/072,924

(22) Filed: Feb. 12, 2002

(51) Int. Cl. G06F 7/00

(52) U.S. Cl. 707/104.1

(57) ABSTRACT

An automatic storage and retrieval system and a method for operating the system are proposed, in which the automatic storage and retrieval system (AS/RS) is used to connect a user's computer device through a communication network to an AS/RS programmable logic controller (PLC), wherein a user is provided with an identification number for loginning the AS/RS, and a daily required material report is displayed in the user's computer device for allowing the user to select a material from the material report, so as to control the AS/RS PLC to store or retrieve the selected material in the case of the user matching a corresponding storage bin for the selected material in identification number, or else, the material storage or retrieval is inhibited by the AS/RS.

### FIELD OF THE INVENTION

The present invention relates to automatic storage and retrieval systems and methods for operating the systems, and more particularly, to an automatic storage and retrieval system and a method for operating the system, which allow a material selected by a user through the automatic storage and retrieval system (AS/RS) to be stored in or retrieved from its corresponding storage bin by an AS/RS programmable logic controller (PLC) according to the authorized right of the user.

### BACKGROUND OF THE INVENTION

Conventionally, automation of internal operation for an enterprise is desired for improving the operational and production efficiency and reducing the cost. In view of an enterprise resource planning (ERP) system, as it incorporates the integration of a computer and network, allowing the simultaneous controlling in real time to be achieved and the operational process to be simplified.

Illustrated in FIG. 1 is a conventional method of using the ERP system for operating an automatic storage and retrieval system (AS/RS). First in step S10, the ERP system processes information of materials to be moved by a user and accordingly generates a material report. In step S11, the material report is printed out by the user. In step S12, an AS/RS PLC is manually operated by the user in terms of the printed report obtained from step S11. In step S13, an AS/RS receives the instructions from the AS/RS PLC so as to move the materials for the user.

The conventional method for operating the AS/RS, however, has the following disadvantages: the AS/RS PLC is operated without access control, so that the user can operate a storage bin that is assigned to another person, thereby making the material management more difficult; and the AS/RS PLC is manually operated by a user in terms of a printed report, thereby consuming considerable time and manpower, and making errors of mistaking storage bins liable to occur.

In view of the above disadvantages of the conventional art, it is desired to develop an automatic storage and retrieval system and a method for operating the system, so as to automatically operate an AS/RS PLC with access control for storing or retrieving materials.

### SUMMARY OF THE INVENTION

A primary objective of the present invention is to provide an automatic storage and retrieval system and a method for operating the system, that can check the identity of a user to determine whether the user has authorization to operate a material or a storage bin and then can automatically inform an AS/RS PLC to operate a storage bin to store or retrieve material according to the material selected by the user.

To accomplish the above and other objectives, the present invention proposes a novel method for operating an automatic storage and retrieval system (AS/RS), wherein the automatic storage and retrieval system is used to connect a user's computer device to an AS/RS programmable logic controller (PLC) through a communication network, and has a first database for storing a plurality of storage bin data each including a material, a corresponding storage bin for storing the material, controlling authorization for identifying the storage bin and an identification number corresponding to the storage bin.

The method for operating an AS/RS of the invention comprises the steps of (1) displaying via the AS/RS a daily required material report in a browser of the user's computer device after a user loginning the AS/RS through an identification number provided for the user, and receiving a material selected from the material report by the user; (2) searching via the AS/RS in the first database for a storage bin datum relating to the material selected by the user, and determine if the identification number of the user is identical to that of the searched datum, wherein if the user does not match the searched datum in identification number, then step (3) is followed; or else, a corresponding storage bin for the selected material is obtained from the searched datum, and then step (4) is followed; (3) sending via the AS/RS a message showing no authorization for handling the selected material to the user's computer device, and returning to the step (1); and (4) informing the AS/RS PLC to operate the obtained storage bin for storing or retrieving the selected material.

Moreover, after the step (4), the method for operating an AS/RS of the invention further comprises a step (5) of storing data relating to activities performed by the user loginning the AS/RS in a second database so as to allow operation of the AS/RS to be monitored in real time, wherein the second database stores a plurality of records, each including the identification number of the user, login time, the selected material or the operated storage bin.

An automatic storage and retrieval system (AS/RS) proposed in the invention is used to connect a user's computer device through a communication network to an AS/RS programmable logic controller (PLC), wherein a user is provided with an identification number for loginning the AS/RS, and a daily required material report is displayed in the user's computer device for allowing the user to select a material from the material report, so as to control the AS/RS PLC to store or retrieve the selected material.

The AS/RS of the invention comprises: a first database for storing a plurality of storage bin data, each including a material, a corresponding storage bin for the material, controlling authorization for identifying the storage bin and an corresponding identification number for the storage bin; and a database server for processing interaction between the first database and the user, so as to search in the first database for a storage bin datum corresponding to the material selected by the user, and determine if the identification number of the user is identical to that of the searched datum, wherein if the user matches the searched datum in identification number, then the AS/RS automatically informs the AS/RS PLC to operate a corresponding storage bin obtained from the searched datum for storing or retrieving the selected material; if the user identity does not match the searched datum in identification number, then the AS/RS inhibits the material storage or retrieval.

Moreover, the AS/RS of the invention farther comprises a second database for storing records relating to activities performed by the user loginning the AS/RS, wherein the records each includes the identification number of the user, login time, the selected material or the operated storage bin.

### BRIEF DESCRIPTION OF THE DRAWINGS

The present invention may best be understood through the following description with reference to the accompanying drawings, in which:

FIG. 1 (PRIOR ART) is a schematic diagram showing a conventional method for operating an automatic storage and retrieval system;

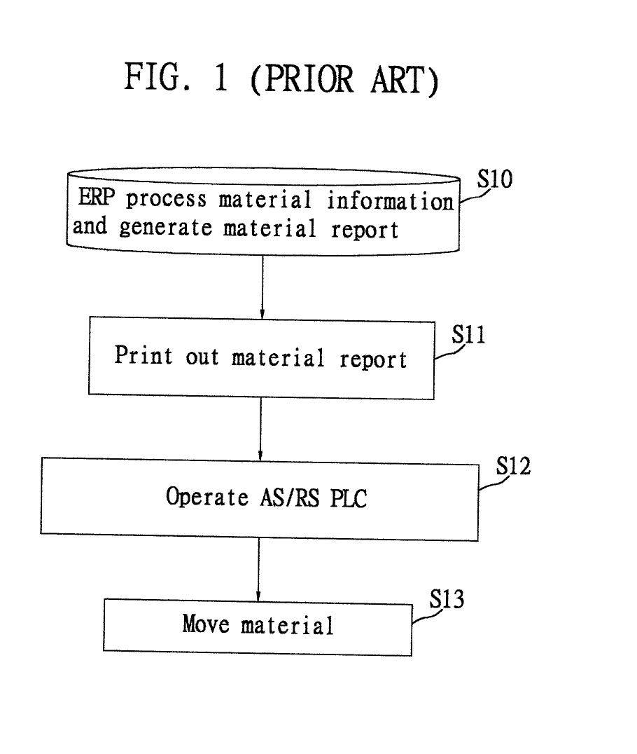

FIG. 2 is a schematic diagram showing system architecture for a preferred embodiment of the automatic storage and retrieval system of the invention; and

FIG. 3 is a schematic diagram showing a preferred embodiment of the method for operating the automatic storage and retrieval system of the invention.

### DETAILED DESCRIPTION OF THE PREFERRED EMBODIMENT

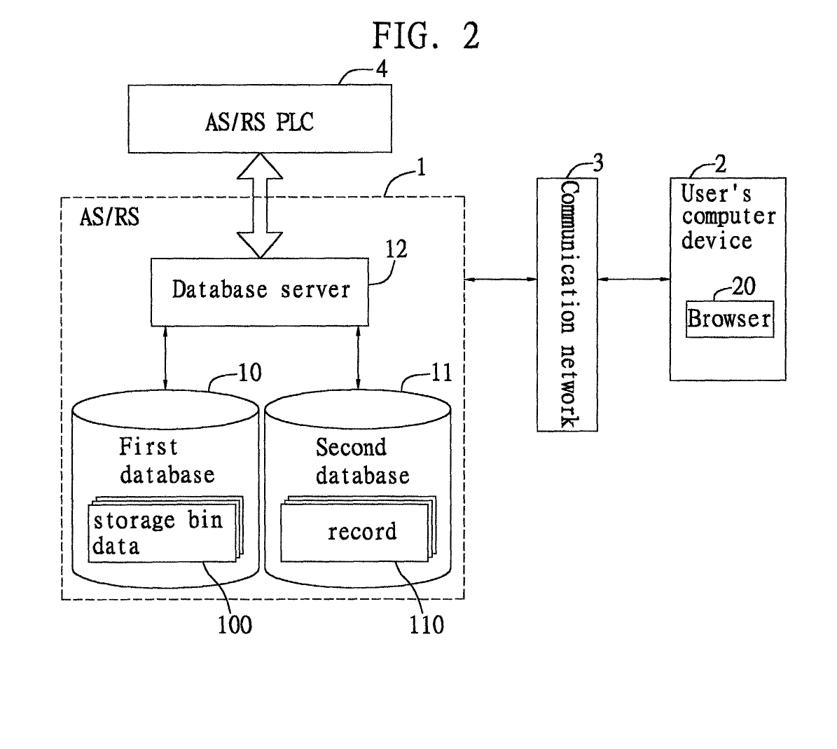

Illustrated in FIG. 2 is system architecture for a preferred embodiment of the automatic storage and retrieval system (AS/RS) 1 of the invention. As shown, the AS/RS 1 of the invention is adapted to connect a user's computer device 2 to an AS/RS programmable logic controller (PLC) 4 through a communication network 3 such as internet or intranet. A user is provided with an identification number for use in loginning the AS/RS 1, and then a daily required material report is displayed in a browser 20 of the user's computer device 2, for allowing the user to directly select a desired material from the material report and the AS/RS PLC 4 to store or retrieve the material. The AS/RS 1 comprises a first database 10, a second database 11 and a database server 12.

The first database 10 is used for storing data 100 relating to material storage bins. The storage bin data 100 each includes a material, a corresponding storage bin for storing the material, controlling authorization for identifying the storage bin and an identification number corresponding to the storage bin, wherein the identification number provides restriction on controlling authorization for moving a storage bin. For example, a storage bin managed by a particular user has its identification number identical to that of the user, in this case, another user having a different identification number is not able to move the storage bin due to no coincidence in identification number.

The second database 11 is used for storing records 110 relating to activities performed by a user loginning the AS/RS 1, wherein each of the records 110 includes an identification number of the user, login time, a material selected by the user or a storage bin moved by the user, so as to allow material storage or retrieval to be monitored in real time. The database server 12 can process interaction between a user and the first and second databases 10, 11 in the use of structured query language (SQL) statements. In operation, when a user logins the AS/RS 1 and selects a material, the database server 12 then searches in the first database 10 for a storage bin datum 100 corresponding to the selected material and determines if an identification number of the user matches that of the datum 100. In the case of coincidence in identification number, the AS/RS PLC 4 is allowed to move the selected material to or from a corresponding storage bin according to the datum 100; if the user does not match the datum 100 in identification number, the AS/RS 1 inhibits the AS/RS PLC 4 to move the selected material.

Therefore, with the integration of the database server 12 and the first and second database 10, 11, the AS/RS 1 of the invention provides an automatic storage and retrieval method for use with controlling authorization, so as to allow material storage and retrieval to be precisely and easily managed.

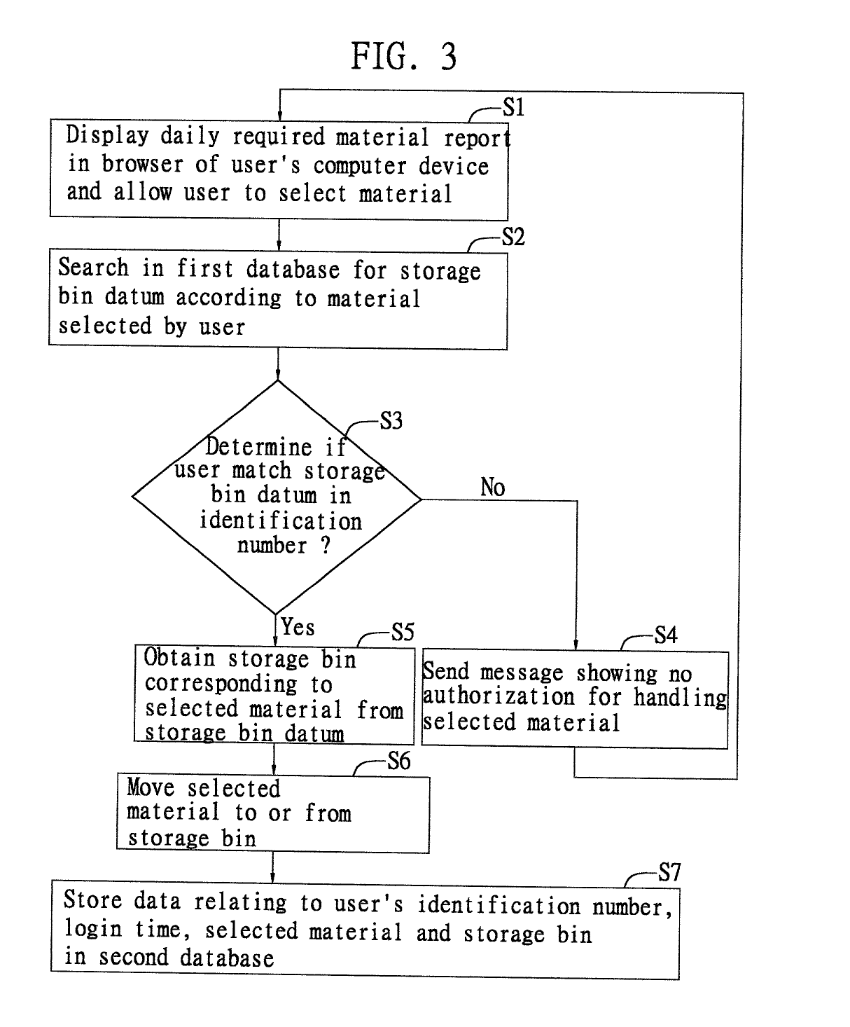

FIG. 3 illustrates a preferred embodiment of the method for operating the automatic storage and retrieval system (AS/RS) of the invention. FIGS. 2 and 3 are used to depict the method for operating the AS/RS of the invention.

In the method for operating the AS/RS of the invention, the user's computer device 2 is connected to the AS/RS 1 through the communication network 3 for automatically control the AS/RS PLC 4 to operate storage bins. After a user having an identification number logins the AS/RS 1, first in step S1, the AS/RS 1 displays a daily required material report in the browser 20 of the user's computer device 2 through the communication network 3, for allowing the user to select a material form the material report. Thereafter, step S2 is followed.

In step S2, the database server 12 searches in the first database 10 for a storage bin datum 100 corresponding to the material selected by the user, in a manner as to execute SQL statements to conduct the search. Thereafter, step S3 is followed.

In step S3, the AS/RS 1 determines if the user has an identification number matching that of the storage bin datum 100. In the case of no coincidence in identification number, step S4 is followed, or else step S5 is followed.

In step S4, due to the user not identical to the storage bin datum 100 in identification number, the AS/RS 1 generates and sends a message showing no authorization for handling the selected material to the user's computer device 2. Thereafter, step S1 is followed.

In step S5, due to coincidence in identification number between the user and the storage bin datum 100, the AS/RS 1 obtains information of a corresponding storage bin for the selected material from the storage bin datum 100. Thereafter, step S6 is followed.

In step S6, the AS/RS PLC 4 moves the selected material to or from the corresponding storage bin. Thereafter, step S7 is followed.

In step S7, the AS/RS 1 stores a record 110 in the second database 11, wherein the record includes data relating to the user's identification number, the login time, the material selected by the user or the storage bin for the selected material.

In conclusion of the above mentioned, the automatic storage and retrieval system (AS/RS) 1 of the invention can operate the AS/RS PLC 4 automatically for material storage or retrieval without requiring a manually printed report. Therefore, the AS/RS 1 allows a material selected by a user through loginning the AS/RS 1 to be moved to or from a corresponding storage bin according to the user's identification number. This makes the material storage or retrieval easily controlled and monitored in real time.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for operating an automatic storage and retrieval system, wherein the automatic storage and retrieval system (AS/RS) is used to connect a user's computer device to an AS/RS programmable logic controller (PLC) through a communication network, and has a first database for storing a plurality of storage bin data each including a material, a corresponding storage bin for storing the material, controlling authorization for identifying the storage bin and an identification number corresponding to the storage bin; the method comprising the steps of:
(1) displaying via the AS/RS a daily required material report in a browser of the user's computer device after a user loginning the AS/RS through an identification number provided for the user, and receiving a material selected from the material report by the user;
(2) searching via the AS/RS in the first database for a storage bin datum relating to the material selected by the user, and determine if the identification number of the user is identical to that of the searched datum, wherein if the user does not match the searched datum in identification number, then step (3) is followed; or else, a corresponding storage bin for the selected material is obtained from the searched datum, and then step (4) is followed;
(3) sending via the AS/RS a message showing no authorization for handling the selected material to the user's computer device, and returning to the step (1); and
(4) informing the AS/RS PLC to operate the obtained storage bin for storing or retrieving the selected material.

2. The method of claim 1, after the step (4), further comprising a step (5) of storing data relating to activities performed by the user loginning the AS/RS in a second database so as to allow operation of the AS/RS to be monitored in real time.

3. The method of claim 2, wherein the second database stores a plurality of records, which each includes the identification number of the user, login time, the selected material or the operated storage bin.

4. The method of claim 1, wherein the user's computer device is a computer.

5. The method of claim 4, wherein the computer includes a browser for allowing the user to input a material to be selected thereto and sending a request to the AS/RS for material storage or retrieval.

6. The method of claim 1, wherein the automatic storage and retrieval system comprises:
the first database; and
a database server for executing the step (1) of receiving the material selected by the user, and for executing the step (3) of sending the message or the step (4) of storing or retrieving the selected material according to the determination in the step (2).

7. The method of claim 3, wherein the automatic storage and retrieval system comprises:
the first database;
the second database; and
a database server for executing the step (1) of receiving the material selected by the user, and for executing the step (3) of sending the message or the step (4) of storing or retrieving the selected material according to the determination in the step (2), as well as for executing the step (5) of storing the records.

8. The method of claim 6, wherein the database server employs structured query language (SQL) statements for processing interaction between the first database and the user.

9. The method of claim 7, wherein the database server employs SQL statements for processing interaction between the user and the first and second databases.

10. The method of claim 7, wherein the communication network is internet or intranet.

11. An automatic storage and retrieval system (AS/RS) for use to connect a user's computer device through a communication network to an AS/IRS programmable logic controller (PLC), wherein a user is provided with an identification number for loginning the AS/RS, and a daily required material report is displayed in the user's computer device for allowing the user to select a material from the material report, so as to control the AS/RS PLC to store or retrieve the selected material; the AS/RS comprising:
a first database for storing a plurality of storage bin data, each including a material, a corresponding storage bin for the material, controlling authorization for identifying the storage bin and an corresponding identification number for the storage bin; and
a database server for processing interaction between the first database and the user, so as to search in the first database for a storage bin datum corresponding to the material selected by the user, and determine if the identification number of the user is identical to that of the searched datum, wherein if the user matches the searched datum in identification number, then the AS/RS automatically informs the AS/RS PLC to operate a corresponding storage bin obtained from the searched datum for storing or retrieving the selected material; if the user identity does not match the searched datum in identification number, then the AS/RS inhibits the material storage or retrieval.

12. The AS/RS of claim 11, wherein the database server employs SQL statements for processing interaction between the user and the first and second databases.

13. The AS/RS of claim 11, further comprising a second database for storing records relating to activities performed by the user loginning the AS/RS.

14. The AS/RS of claim 13, wherein the database server employs SQL statements for processing interaction between the user and the first and second databases.

15. The AS/RS of claim 13, wherein the records each includes the identification number of the user, login time, the selected material or the operated storage bin.

16. The AS/RS of claim 11, wherein the user's computer device is a computer.

17. The AS/RS of claim 16, wherein the computer includes a browser for allowing the user to input a material to be selected thereto and sending a request to the AS/RS for material storage or retrieval.

18. The AS/RS of claim 11, wherein the communication network is internet or intranet.
